(19) United States
(12) Patent Application Publication
(10) Pub. No.: US 2018/0245890 A1
(43) Pub. Date: Aug. 30, 2018

(54) Method To Neutralize Violent Aggressors

(71) Applicant: Cris Allen, Las Vegas, NV (US)

(72) Inventor: Cris Allen, Las Vegas, NV (US)

(21) Appl. No.: 15/902,835

(22) Filed: Feb. 22, 2018

Related U.S. Application Data
(60) Provisional application No. 62/462,897, filed on Feb. 23, 2017.

(51) Int. Cl. F41H 13/00; G08B 27/00; G08B 15/00; F42B 12/54; B64C 39/02; G06N 5/02

(52) U.S. Cl. CPC F41H 13/00; G08B 27/001; G08B 15/00; B64C 2201/126; B64C 39/024; G06N 5/022; F42B 12/54

(57) ABSTRACT

This method utilizes drones, signals technology, and non-lethal tranquilizer rounds to neutralize violent aggressors that pose a societal threat. The method described creates the unexpected result of allowing the user to take a draconian approach to said threats with minimal loss of life.

### BACKGROUND OF THE ART

Battlefield Fatalities and Injuries

Jobs with the highest rate of fatalities and injuries should top the list of positions replaced by drones. Battlefield injuries such as amputations, brain damage, and organ damage can require decades of ongoing medical care. The stress of battle can lead to long-term post traumatic stress disorder, which can have serious consequences for soldiers and their families. Though the military is making use of drone technology, battlefield casualties are still too high and could be alleviated substantially with this method.

Terrorist Incursions

In some parts of the world terrorists can easily enter a town and kidnap hundreds of hostages or even take over the town entirely. Local officials have few options aside from putting citizens in harms way to stop invaders who are heavily armed and extremely violent.

Collateral Damage

Current terrorist-abatement methodologies leave decision-makers struggling with the option of either killing too many people to stop a societal threat, or too few, thereby allowing the threat to fester. Terrorists often mingle with civilians inside buildings and their pursuers cannot take them out without collateral damage, i.e., severe injury or death to civilians. One common methodology involves blowing up entire buildings in order to kill a small number of targets inside. Unintended casualties can create horrifying visual material that finds its way into effective terrorist recruittnent campaigns. This ultimately defeats the purpose of reducing the number of terrorists.

Hostage Rescue

It is difficult to rescue hostages without putting the lives of both the hostages and the rescuers at risk. Hostage-takers count on these risk factors to maintain control.

This method allows responders to dispatch drones that fire light explosives to create entry holes in the walls or windows of a building. The drone fires a barrage of non-lethal smart bullets through said entry holes in rapid succession. The non-lethal smart bullets draw upon radar, transmitting cameras, infrared cameras, and swarmbot technology to guide every bullet to a human target. AI technology allows the system to calculate the mass of the target and calibrate the narcotic dosage of the non-lethal rounds in a variety of ways so smaller individuals, such as children, are not over-dosed. Once the targets are unconscious, a rescue operation is far less risky. Bio-data transmitters and motion detectors send signals to recovery teams, letting them know which targets are immobilized and their degree of incapacitation. The system could deliver a time-release narcotic, or employ other methods to keep a target sedated for an extended period of time.

Minimizing Collateral Damage

This method dramatically reduces collateral damage which, in turn, takes effective terrorist recruitment tools off the table. Minimizing collateral damage also reduces political fallout.

Stopping Terrorists at City Limits

The method described is ideal for stopping a terrorist incursion into a town or city by allowing an effective alternative to sacrificing the lives of citizens. The method allows trained personnel to swiftly and effectively respond to a threat with drones and non-lethal ordnance in order to minimize loss of life on both sides. Said method could stop tanks, aircraft, trucks, SUVs, foot soldiers, and other targets. At no time are personnel put at risk aside from casualty recovery wherein the risk factor is dramatically reduced.

Clear and Hold Strategy

A scenario involving terrorists or enemy soldiers taking refuge in a building, or buildings, could be resolved using the wall-penetration strategy described above. This method can also be applied to an occupation scenario wherein enemy soldiers must be smoked out of buildings. This method can be applied building-to-building in a clear-and-hold strategy. The method could also employ AI and signal technology to locate occupants in the building.

Disincentivizing Terrorists

Being captured alive presents the most powerful disincentive to terrorists. A lifetime wasted in a bare prison cell is the ultimate nightmare for ideological aggressors who were looking forward to either tyrannizing people under their control, or at the very least, having a glorious martyr's death.

Lowering Battlefield Fatalities

Perhaps the biggest benefit this method provides is the potential to radically reduce battlefield casualties. This method could combine fleets of aerial drones, land-roving drones, and aquatic drones, all armed with a variety of ordnance, to dominate and control a variety of battlefield scenarios. This eliminates the need to send live soldiers into lethal scenarios to be maimed and killed.

Lowering Medical Costs

Dramatically reducing the need for frontline soldiers will automatically reduce chronic/permanent injuries as well as post traumatic stress disorder. This could save the government billions in veteran's medical expenses.

This method can save the lives of 5 categories of people.
1. Defensive soldiers
2. Civilian populations of towns and cities
3. Hostages
4. Collateral damage (unintended human casualties)
5. Aggressors

This method involves a weapon system that is less expensive to manufacture than conventional weapons used for the same purpose. It could help the government save billions by:
creating a less expensive and more effective means of combatting aggressive forces
using less ordinance, since each smart-bullet is guided to its target
reducing medical expenses by reducing combat injuries, including PTSD

### SUMMARY

This method allows drone pilots (human or AI) to swiftly respond to a threat alert by scrambling a drone, or fleet of drones, including aerial, land-roving, waterborne, and underwater vehicles, or combinations there-of, loaded with a variety of ordnance, including small missiles, light explosives, armor-piercing rounds, smart bullets, and non-lethal tranquilizer rounds.

The method can utilize a combination of electronic technology, including: AI, radar, infra-red cameras, electronic signals (such as radio and microwave), ordnance-mounted transmitting cameras, and swarmbot technology. AI and signals technology allows drones and smart-ordnance to respond effectively to rapidly-updating information. Swarmbot technology can super-impose electronic intelligence upon a swarm of drones, smart-bullets, smart-bombs, and electronically-guided missiles, allowing the system to not only “see” its target, but to assign each piece of ordnance an appropriate target on the fly.

Once in motion, the drones can approach a panoply of threats, such as fleets or divisions of aircraft, water craft, land-roving vehicles, and infantry; with a wide variety of defensive options.

### DESCRIPTION OF THE DRAWING

The drawing is divided into 5 vertical columns. There are three horizontal double-edged arrows near the top of the columns, between columns 2 and 3, columns 3 and 4, and columns 4 and 5. These horizontal arrows represent a consistent cross-current of communication between the four teams. The columns are to be read starting at the top left, reading down (like a newspaper column), and then moving right.

Column 1

The far left column displays an explosion icon with the word “THREAT” in the middle—[FIG. 110]. This icon represents a threat that the Threat Detection Team and apparatus may detect and respond to.

Column 2

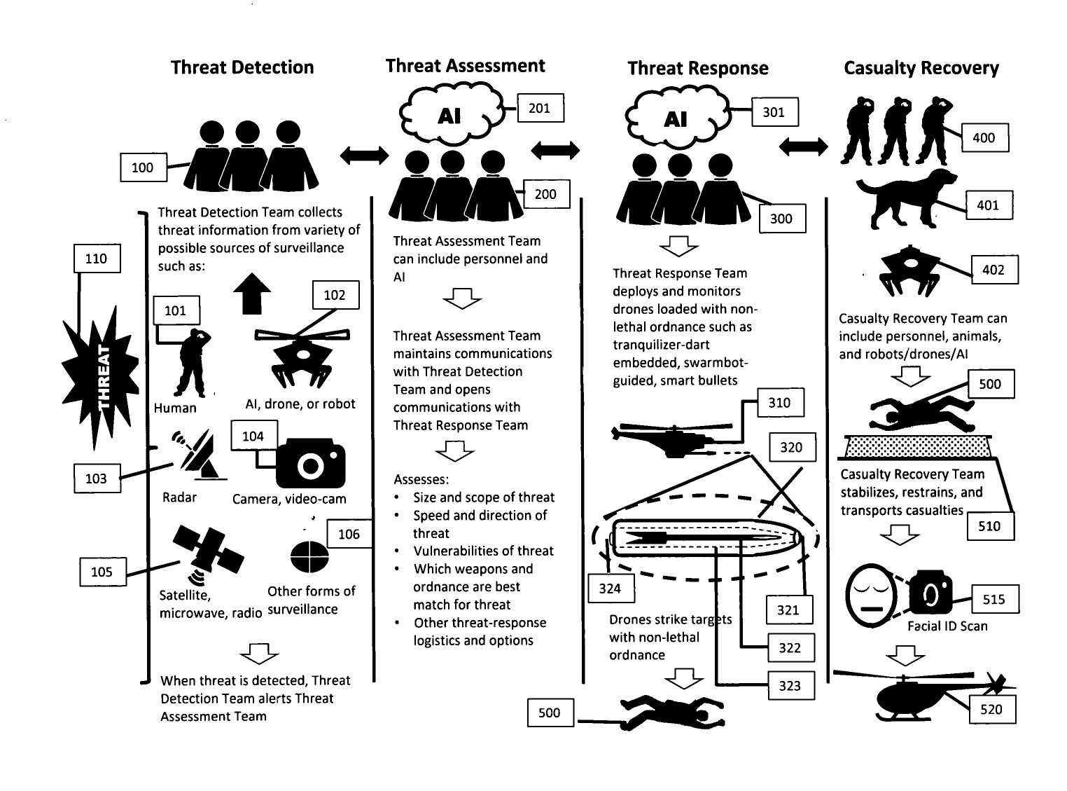

The next column to the right bears the header “Threat Detection.” The icon on top, made up of three peeps, represents the Threat Detection Team—[FIG. 100].

Beneath the Threat Detection Team is a black arrow pointing upward. The arrow represents input from the figures below—icons which represent the Threat Detection crew and apparatus.

Beneath the black arrow are six icons.

[FIG. 101] is a human icon that represents trained personnel who investigate the threat.

[FIG. 102] is a drone icon, part of the Threat Detection apparatus.

[FIG. 103] represents radar equipment and technology, part of the Threat Detection apparatus.

[FIG. 104] represents camera and video equipment/technology, part of the Threat Detection apparatus.

[FIG. 105] represents satellite, microwave, and radio equipment/technology, part of the Threat Detection apparatus.

The black dot with the cross-hatch represents other possible forms of surveillance technology.

The downward arrow represents the task flow of the method described.

Column 3

The next column bears the heading “Threat Assessment.”

The icon on top is a cloud shape with the letters “AI” in the middle [FIG. 201]. This icon represents Artificial Intelligence utilized by the Threat Assessment Team. The icon comprised of 3 peeps is the Threat Assessment Team [FIG. 200] 7The downward arrows represent the task flow as described in the text. The Threat Assessment Team analyzes the size and scope of threat and strategizes an appropriate response based on available resources.

Column 4

The next column bears the heading “Threat Response.”

The icon on top is a cloud shape with the letters “AI” in the middle [FIG. 301]. This icon represents Artificial Intelligence utilized by the Threat Response Team. The next icon below, comprised of 3 peeps, is the Threat Response Team [figure 200].

The downward arrows represent the task flow as described in the text.

The icon just below the text represents an attack vehicle (like a military helicopter) or drone [FIG. 310].

The attack vehicle shoots non-lethal ordnance [FIG. 320] such as a swarmbot-guided, tranquilizer round-imbedded, smart bullets.

The tranquilizer round-imbedded smart bullet icon [FIG. 320] is visually broken down into several parts.

The small circle [FIG. 321] at the right-hand tip of the smart-bullet icon represents a micro-transmitting camera that continuously updates the Threat Response system with rapidly changing information.

The black horizontal image inside the bullet icon [FIG. 322] represents the tranquilizer needle.

The horizontal perforation lines along the bullet icon [FIG. 323] represent the option of bullet casings designed to break apart along pre-designated lines, in order to free the tranquilizer dart from the bullet casing just before impact.

The nodule at the far left-side of the bullet icon [FIG. 324] represents a signal transmitter device which transmits locational data and other data to Threat Response and Casualty Recovery teams.

The icon of a prostrate human [FIG. 500] at the bottom of Column 4 represents a human casualty.

Column 5

The next column bears the heading “Casualty Recovery.”

The top icon, a triple human silhouette, [FIG. 400] represents a human search and recovery crew.

The next icon below, a dog silhouette, [FIG. 401] represents an animal that could assist a recovery crew, such as a search dog, or a pack animal.

The next icon below represents a drone or robot [FIG. 402] that could assist the recovery crew.

The next icon below, a prostrate human Figure [FIG. 500], represents the casualties being recovered.

The next icon below, a stretcher [FIG. 510], represents equipment used to transport casualties.

The next icon below, a face and a camera [FIG. 515], represents casualties' faces being ID scanned for electronic identification.

The next icon below, a helicopter [FIG. 520] represents vehicles used to transport casualties to a processing center.
EMBODIMENTS:
Embodiments for claim 3 which states “The method of claim 1 wherein a threat detection team [100] and/or apparatus collects information regarding a threat.”
In an embodiment, the information could be collected from:
   a. Human surveillance [101]
   b. AI surveillance [102]
   c. Animal surveillance
   d. Drone (or robot) surveillance [102]
   e. Radar surveillance [103]
   f. Electronic camera/audio-visual surveillance[104]
   g. Infrared surveillance
   h. Satellite surveillance[105]
   i. Other surveillance resources
   j. Any combination of the above, inclusive or exclusive
In an embodiment the threat detection team could determine:
   a. Location, direction and traveling speed of targets
   b. Number of human targets on foot
   c. Number of human targets in or on vehicles
   d. Type of vehicles, i.e., trucks, SUVs, tanks, jets, propeller planes, helicopters, boats, other types of vehicles
   e. If vehicles are armored, armor type and characteristics
   f. Types of drones or robots controlled by targets
   g. If targets are wearing body armor
      Type of body armor
      What parts of body are shielded or unshielded
      Ideal entry points for ordnance
   h. Type of weapons and ordnance at target's disposal
   i. Body mass of targets
   j. Other vital information regarding targets
In an embodiment, the threat detection team or apparatus could relay information to a threat assessment team[200][201].
In an embodiment, the threat detection team[100] could also function as the threat assessment team[200][201].
In an embodiment the threat detection team[100] and threat assessment team[200][201] could share team members and resources.
Embodiments for claim 4 which states “The Method of claim 1 wherein threat assessment team[200][201] analyzes data received from threat detection team[100].”
In an embodiment the threat assessment team[200][201] could maintain open lines of communication with threat detection team[100], allowing threat assessment team to suggest further threat detection techniques and request further information.
In an embodiment, the threat assessment team[200][201] could determine:
   a. Force needed to penetrate vehicles, buildings, armor, etc.
   b. Vulnerable penetration points on targets
   c. Which available weapons and ordnance are best match for threat
   d. Other logistics and strategies to neutralize threat threat
Embodiments for claim 5 which states “The Method of claim 2 wherein the threat assessment team[200][201] forms a defensive strategy based on gathered intel and available weaponry.”
   In an embodiment, the threat assessment team[200][201] could devise a response strategy based on:
   a. Available weaponry and ordnance
   b. Available drones/robots
   c. Available AI
   d. Available signal technology
   e. Logistics
   f. Intelligence gathered from threat assessment team
   g. Other intel and data inputs
   h. Other resources
   i. Any combination of the above, inclusive or exclusive
In an embodiment the assessment team could include:
   a. Trained personnel[200]
   b. Artificial intelligence[201]
   c. Other assets
   d. Any combination of the aforementioned, inclusive or exclusive
In an embodiment, the threat assessment team[200][201] could provide analysis based on threat detection data and threat assessment data to a separate threat response team.
In an embodiment, the threat assessment team[200][201] could also function as the threat response team[300][301].
In an embodiment the threat assessment team[200][201] and threat response team[300][301] could share team members.
Embodiments for claim 6 which states “The Method of claim 2 wherein the threat response team deploys drones loaded with electronically-guided tranquilizer rounds, and other ordnance, to neutralize targeted threat with minimal loss of life.”
In an embodiment the threat response team could include:
   a. Trained personnel
   b. Artificial intelligence
   c. Combination of trained personnel and artificial intelligence
In an embodiment drones could be launched from a platform such as:
   a. A tarmac
   b. A hangar
   c. An underground platform
   d. An aircraft carrier
   e. Another type of launching base
In an embodiment drones could be equipped with weaponry, ordnance, and electronics including:
   a. Robot technology
   b. AI
   c. Swarmbot technology
   d. Signal technology
   e. Gun technology,
      including electronic guns
   f. Electronically-guided ordnance
      Including non-lethal ordnance
      Including non-lethal smart-bullets
   g. Conventional ordnance
   h. Other technology
   i. Any combination of the above, inclusive or exclusive
In an embodiment, signal technology (such as radar, infrared cameras, swarm-bot technology, etc.) combined with AI, could give the system visual capability to hone in on its targets.
In an embodiment signal technology could be comprised of:
   a. Satellite signals (radio and microwave)
   b. Cellular tower signals (radio and microwave)
   c. Television signals
   d. Radar signals
   e. Infrared technology
   f. Cable signals (coaxial and fiber-optic)
   g. Other signal technology
   h. Any combination of the above, inclusive or exclusive
In an embodiment drones or robots could include:
   a. UAVs or airborne drones
      Airborne drones could include space traveling drones
   b. Land-roving drones
   c. Waterborne drones
   d. Underwater drones
   e. Drones that can accomplish any combination of aerial, land, overwater, and/or underwater travel and mobility
   f. Swarmbot-guided drones
   g. Other drones
In an embodiment swarmbot-technology could include:
   a. Swarmbot-guided drones
   b. Swarmbot-guided electronic guns
   c. Swarmbot-guided, electronically-guided ordnance
   d. Other swarmbot-guided technology
   e. Any combination of the aforementioned, inclusive or exclusive
In an embodiment guns could include:
   a. Any apparatus that launches or fires a projectile
   b. Electronic machine guns
In an embodiment non-lethal ordnance could include:
   a. Tranquilizer-embedded smart bullets
   b. Other non-lethal ordnance
In an embodiment a tranquilizer-embedded smart bullet could be equipped with signal technology to:
   a. Provide further information to assessment and response teams
   b. Assist guidance technology
   c. Determine body mass of target
In an embodiment, said signal technology could include:
   a. Radar
   b. Sonar
   c. Transmitting camera
   d. Infrared signal
   e. GPS or similar signal
      To alert response system as to which targets have been hit and which have not
      To assist recovery team/apparatus in locating targets
   f. Motion detection technology
      to determine which targets are incapacitated and which are not
   g. Biometric detection and signaling devices to determine physiological information such as:
      Heart rate
      Blood pressure
      Temperature
      Brain-wave activity
      Hormone levels
      Level of narcotic in system
      Other physiological information
   h. Other signal technology to assist in assessing and responding to threat
In an embodiment the tranquilizer delivery apparatus could include:
   a. An internal device that adjusts dosage of narcotic to body mass of target
   b. A device that continues to titrate additional narcotic into the target to keep target unconscious for an extended period of time
In an embodiment, smart-bullet functionality could be divided such that some smart-bullets could be programmed to gather and transmit data while other smart-bullets could be programmed to deliver a payload to the target.
In an embodiment, the drones could be equipped with technologies such as: swarmbot AI, infrared, radar, sonar, transmitting camera, computer, and other technology and any combination thereof, both inclusive and exclusive.
In an embodiment the drones could contain a variety of tranquilizer-embedded smart-bullets with different narcotic dosages, such that the AI system could match the narcotic dosage of a specific bullet with the body mass of a specific target.
In an embodiment the AI system could select two or more low-dosage bullets to meet the dosage needs of a large target.
In an embodiment the tranquilizer-embedded smart bullets[320] could contain a mechanism to titrate narcotic into the body of a target to maintain unconsciousness over an extended period of time.
In an embodiment a target could be struck with one active tranquilizer-embedded smart round that takes effect right away, and struck by one (or more) tranquilizer-embedded smart rounds that take effect as the narcotic of first tranquilizer round, and successive rounds, wears off.
In an embodiment, the system could utilize signal technology and AI to select an ideal entry point on the targets for the smart-bullets and other ordnance.
In an embodiment conventional ordnance could include:
   a. Bullets
   b. Armor piercing bullets
   c. Explosive devices
      including wall-penetrating explosives
   d. Missiles
In an embodiment electronically-guided ordnance could include:
   a. Smart bullets, including:
      tranquilizer rounds [320]
      armor-piercing rounds
      swarm-bot guided
   b. Guided missiles
      including Swarmbot-guided
In an embodiment the drones could have a caddy of electronic guns housed in or on the drones.
In a variation of this embodiment, drones could include a caddy of more than one electronic guns, wherein each gun is loaded with a specific type of ordnance, such that said ordnance is different from the ordnance loaded in the other gun(s).
In a variation of this embodiment, the drones could contain one or more electronic guns such that each gun barrel could contain either the same type or different type ordnance as other barrels in the same gun.
In a variation of this embodiment, in a fleet of one or more drones, each drone could be loaded with a specific type of ordnance that is different from the ordnance loaded in other drones.
In a variation of this embodiment, a single drone could be loaded with a variety of ordnance.
In a variation of this embodiment, one or more drones could be outfitted with missiles used to penetrate tanks, armored trucks, and other armored vehicles or structures.
In an embodiment, drones could contain tank-penetration or other vehicle-penetration devices that result in noxious elements introduced to the interior of said vehicle that would compel occupants to disembark.
In an embodiment, the smart bullets could send a locational signal so they could be recovered and recycled.
In an embodiment, the smart bullets could self-destruct if recovered by an enemy.
In an embodiment, the outer casing of the smart bullet could break apart along pre-designated lines [323] before impact to free the tranquilizer dart[322] within.
In an embodiment, the smart bullet could be mounted with a micro-transmitting-camera to continuously update system with rapidly changing information.
In an embodiment the smart bullet could be mounted with a signal transmitter device[324].
Embodiments for claim 7 which states “The Method of claim 1 wherein casualty recovery team(s)[400][401][402] arrive onsite and prepare human targets for transportation.”
In an embodiment, casualty recovery teams could include:
   a. Humans[400]
   b. Animals (canines or pack animals for example)[401]
   c. Robots/drones[402]
   d. Other casualty recovery resources
   e. Any combination of the above, inclusive or exclusive
In an embodiment casualty recovery apparatus could include:
   a. Transportation vehicles[520]
   b. Protective gear for recovery team including
      Body armor
      Helmets
      Faceguards
      Defensive weapons
      Other protective gear
   c. Human restraints
      Such as handcuffs, straps, cords, tape, wrapping material, bags or boxes
      Other human restraints
   d. Bomb detection apparatus
   e. Bomb dismantling and disposal equipment and personnel
      Including human and/or robot
   f. Side-arm detection apparatus
   g. Medical equipment
   h. Medicine
In an embodiment casualty recovery teams could bind human targets[500] such that they pose little or no threat if they become conscious during transportation.

I claim:

1. A Method of apprehending a threat [110] posed toward one or more humans, and/or infrastructure, utilizing non-lethal ordnance [320] to capture and control the targeted threat with minimal loss of life; comprising the steps of detecting the threat, assessing the threat, strategizing an effective and minimally lethal response to the threat, carrying out non-lethal strategy to neutralize threat, and recovering one or more casualties[500]*.

2. The Method of claim 1 wherein a threat detection team** [100], assessment team [200][201], response team [300, 301], and recovery team [400][410][420] utilize signal technology [103][104][105], drones [102][420], swarmbot technology, ordnance delivery technology such as guns*** (including electronic guns), non-lethal ordnance, [320] and conventional ordnance, electronically-guided ordnance [320], other signal or weapon technology, any combination of the aforementioned, inclusive or exclusive, in the course of abating a threat to a human population or infrastructure.
*Casualties could include uninjured targets who are rendered unconscious by a narcotic round.
**A team could include, humans, animals, AI, robots, drones, swarmbot technology, other personnel or assets, any combination of the aforementioned, inclusive or exclusive.
***A gun could be any apparatus that fires or launches a projectile.

3. The method of claim 1 wherein a threat detection team [100] and/or apparatus collects information regarding a threat.

4. The Method of claim 1 wherein threat assessment team[200][201] analyzes data received from threat detection team[100].

5. The Method of claim 2 wherein the threat assessment team[200][201] forms a defensive strategy based on gathered intel and available weaponry.

6. The Method of claim 2 wherein the threat response team deploys drones loaded with electronically-guided tranquilizer rounds, and other ordnance, to neutralize targeted threat with minimal loss of life.

7. The Method of claim 1 wherein casualty recovery team(s)[400][401][402] arrive onsite and prepare human targets for transportation.

8. The Method of claim 1 wherein the casualty recovery team loads human targets[500] onto transportation vehicles[520].

9. The Method of claim 1 wherein the casualty recovery team scans the faces of casualties [and enters data into facial recognition database for identification purposes [515].

10. The Method of claim 1 wherein the casualty recovery team transports human targets to processing site.
